(19) United States
(12) Patent Application Publication
(10) Pub. No.: US 2009/0071768 A1
(43) Pub. Date: Mar. 19, 2009

(54) Mechanical Disc Braking Assembly

(76) Inventor: Brian Anthony Paulsen, Nigel (ZA)

Correspondence Address: HAHN AND MOODLEY, LLP, P.O. BOX 52050, MINNEAPOLIS, MN, 55402, US

(21) Appl. No.: 11/719,647

(22) PCT Filed: Nov. 17, 2004
(86) PCT No.: PCT/ZA04/00143

§ 371 Date: Oct. 29, 2007

(51) Int. Cl. F16D 55/228

(52) U.S. Cl. 188/72.7

(57) ABSTRACT

The disc brake assembly (10) comprises a caliper (4). The caliper (4) can be mounted on a vehicle, such as a trailer, for example, in a conventional fashion. The disc brake assembly further includes a cam (5) and a lever (11), seated on a cam shaft (5.1). The cam shaft (5.1) is mounted on the caliper (4) for angular displacement, as indicated by arrows BB. To this end, a bush (1) is provided. Appropriate spacers and spring washers can be provided to retain the cam (5) in position on the caliper (4).

### FIELD OF THE INVENTION

This invention relates to a mechanical disc brake assembly. In particular, the invention relates to a brake assembly, to a vehicle and to a trailer.

### BACKGROUND OF THE INVENTION

When a vehicle, such as a trailer, or the like, which does not have brakes, is being towed behind another vehicle, the trailer can overrun the towing vehicle in certain circumstances, such as when brakes are suddenly applied on the towing vehicle, for example. This can result in loss of control and even jack-knifing. Naturally, when a vehicle at speed loses control, an accident can occur. For this reason, it would be advantageous if such trailers, for example, had braking systems of their own.

Disregarding other braking systems fitted to heavy commercial vehicles and trailers, and the like, current braking systems of trailers fall into the mechanical cable/rod type. This type of braking system is typically wholly independent of the towing vehicle's braking system.

It is an object of this invention to provide a brake assembly which can be fitted to trailers which traditionally have been supplied without a braking system of their own. It is a further object of this invention to provide a brake assembly for such trailers and which can be coupled to a braking system of a towing vehicle so as to be actuated in sympathy with actuation of the braking system of the towing vehicle.

### SUMMARY OF THE INVENTION

According to one aspect of the invention, there is provided a brake assembly including a body, mounting means on the body, the mounting means being arranged to enable two brake pads to be mounted on the body such that the brake pads face each other and are selectively displaceable toward and away from each other, urging means on the body, the urging means being arranged selectively to urge the brake pads toward each other and a cam on the body, the cam being operatively associated with the urging means so as to cause the urging means to urge the brake pads toward each other in response to the cam being displaced angularly, thereby to cause the brake pads frictionally to engage a brake disc, in use.

The urging means may include at least one urging member mounted on the body to transfer angular displacement of the cam into displacement of one of the brake pads toward the other.

The at least one urging member may be mounted on the body at a position to ride against the cam.

The at least one urging member may be mounted on the body at a position to ride against the cam and against the one brake pad.

The brake assembly may further include a pivotal connection through which the one urging member is mounted on the body so that angular displacement of the cam causes angular displacement of the one urging member so as to transfer angular displacement of the cam into displacement of the one brake pad.

The urging means may further include another urging member mounted on the body to transmit angular displacement of the cam into displacement of the other brake pad toward the one brake pad.

The other urging member may be mounted on the body at a position to ride against the cam.

The other urging member may be mounted on the body at a position to ride against the cam and against the other brake pad.

The brake assembly may further include a pivotal connection through which the other urging member is mounted on the body so that angular displacement of the cam causes angular displacement of the other urging member so as to transfer angular displacement of the cam into displacement of the other brake pad.

Both urging members may be mounted on the body by means of the pivotal connection so that angular displacement of the cam causes angular displacement of both urging members so as to transfer angular displacement of the cam into displacement of both brake pads toward each other.

The brake assembly may further include a lever mounted on the body for angular displacement relative to the body, the lever being operatively connected to the cam to cause the cam to displace angularly in response to angular displacement of the lever.

The brake assembly may further include a cam shaft mounted on the body for angular displacement relative to the body, the cam and the lever being secured on the cam shaft thereby to be angularly displaceably mounted on the body.

According to another aspect of the invention, there is provided a vehicle having a brake assembly as described above.

According to a further aspect of the invention, there is provided a trailer having a brake assembly as described above.

According to another aspect of the invention, there is provided a mechanical disc braking assembly comprising a caliper carrying:
a rotatable cam seated upon a cam shaft connected to a lever arm
a rotatable knuckle seated upon a pin and
a c-shaped arm rotatable upon said pin.

According to a further aspect of the present invention there is provided a mechanical disc braking assembly comprising a caliper having a carrier for a pair of disc pads, such that the disc pads are spaced a distance apart and positioned transversely to the direction of movement of a rotatable knuckle and a c-shaped arm.

The arrangement may be such that, on the application of a force on the lever arm, said rotatable cam exerts a force onto the knuckle and c-shaped arm. The result may be that both disc pads are urged simultaneously into engagement with a disc.

The rotatable cam and mounting of the caliper may cause an even braking pressure to be applied to the disc by both disc pads.

The first and the second disc pads may each be guided for movement towards and away from the disc.

Therefore, the invention proposes a disc brake of a type in which brake applying means is associated with a torque taking member to urge at least two disc pads into frictional engagement with corresponding sides of a rotary disc. Carrier means may be provided to inhibit escape of the pads with respect to the disc. The carrier means may include front and rear abutment means to anchor the disc pads in accordance with the direction of disc rotation.

It should be appreciated that the braking system of the invention may be actuated electronically or pneumatically, thereby allowing a reverse maneuver to take place without the driver having to leave the towing vehicle. As soon as forward motion is resumed, the braking system may return to a fully operational state, automatically.

The braking system may also include a mechanical parking brake comprising the aforementioned invention, whereby the actuated lever arm is displaced to cause the cam to rotate while abutting against the knuckle and c-shaped arm thereby causing the knuckle and c-shaped arm to rotate so as to urge the disc pads simultaneously into engagement with a disc.

There has thus been outlined, rather broadly, the most important features of the invention in order that the detailed description thereof that follows may be better understood, and in order that the present contribution to the art may be better appreciated. There are additional features of the invention that will be described hereinafter and which will form part of the subject matter of this disclosure.

### BRIEF DESCRIPTION OF THE DRAWINGS

The invention will now be described, by way of example, with reference to the accompanying diagrammatic drawings, in which;

FIG. 1 shows a schematic three dimensional view of a brake assembly in accordance with the invention;

FIG. 2A shows a schematic side view of the brake assembly when viewed along arrow IIA in FIG. 1;

FIG. 2B shows a schematic end view of the brake assembly when viewed along arrow IIB in FIG. 1;

FIG. 2C shows a schematic plan view of the brake assembly when viewed along arrow IIC in FIG. 1;

FIG. 3 shows a schematic three dimensional exploded view of some components of the brake assembly shown in FIG. 1;

FIG. 4 shows a schematic bottom view of the brake assembly shown in FIG. 1;

FIGS. 5A to 5C show schematic side views of the brake assembly and indicate how the brake assembly is applied in use; and

FIGS. 6A to 6C show schematic three dimensional views of the brake assembly without a carrier.

### DETAILED DESCRIPTION OF PREFERRED EMBODIMENTS

With reference to the drawings, a disc brake assembly embodying the principles and concepts of the present invention is generally designated by reference numeral 10.

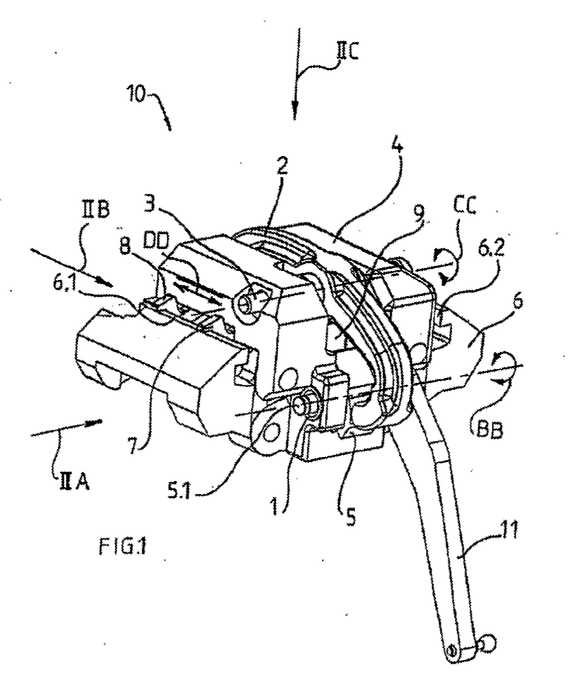

The disc brake assembly 10 comprises a body, or caliper 4. The caliper 4 can be mounted on a vehicle, such as a trailer, for example, in a conventional fashion. The disc brake assembly further includes a cam 5 and a lever, or arm 11, seated on a cam shaft 5.1. The cam shaft 5.1 is mounted on the caliper 4 for angular displacement, as indicated by arrows BB in FIG. 1 of the drawings. To this end, a bush 1 is provided. Appropriate spacers and spring washers can be provided to retain the cam 5 in position on the caliper 4.

The brake assembly 10 further includes an urging member in the form of a rotatable knuckle 9 and another urging member in the form of a generally c-shaped arm 2. The knuckle 9 and the c-shaped arm 2 are mounted on the caliper 4 by means of a pin 3 for angular displacement relative to the caliper 4 as indicated by arrows CC.

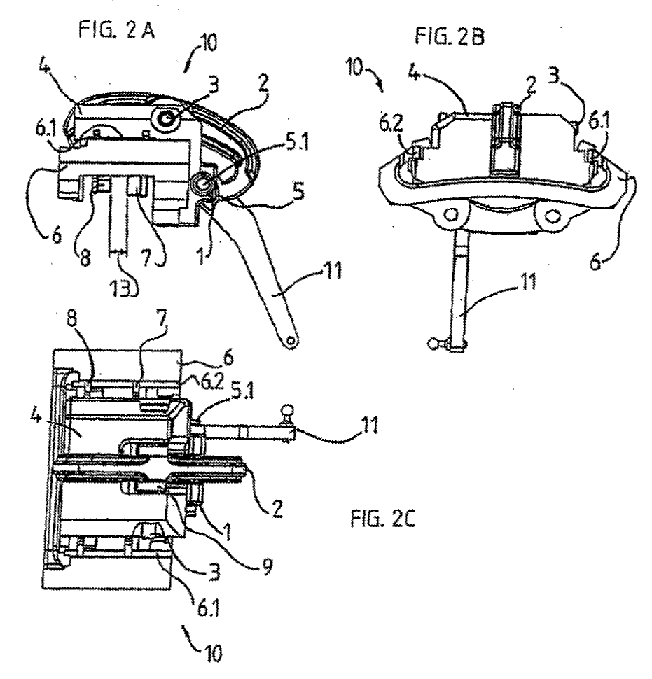

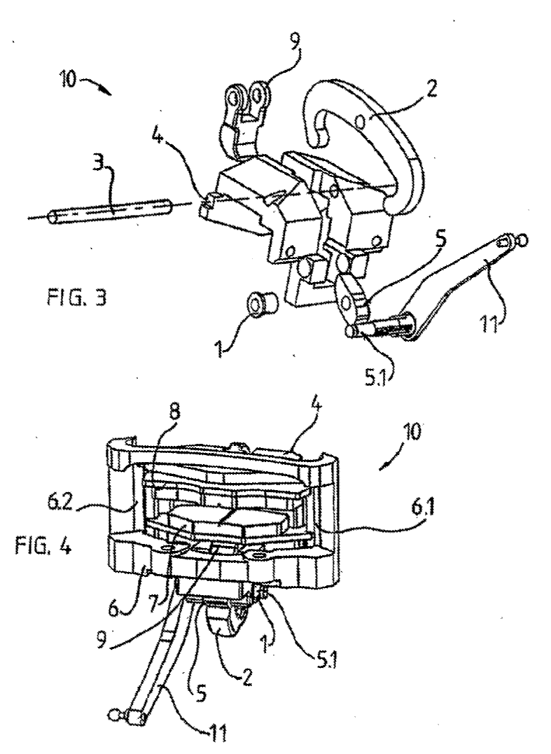

The disc brake assembly 10 further includes a carrier 6. The carrier 6 has mounting means for a pair of brake, or disc pads 7 and 8. The pads 7, 8 are mountable on the carrier 6 so as to define a space 13 therebetween, as can best be seen in FIG. 2A of the drawings. When the brake pads are mounted on the carrier 6 they are positioned to extend transversely relative to a direction of movement of the rotatable knuckle 9 and the c-shaped arm 2.

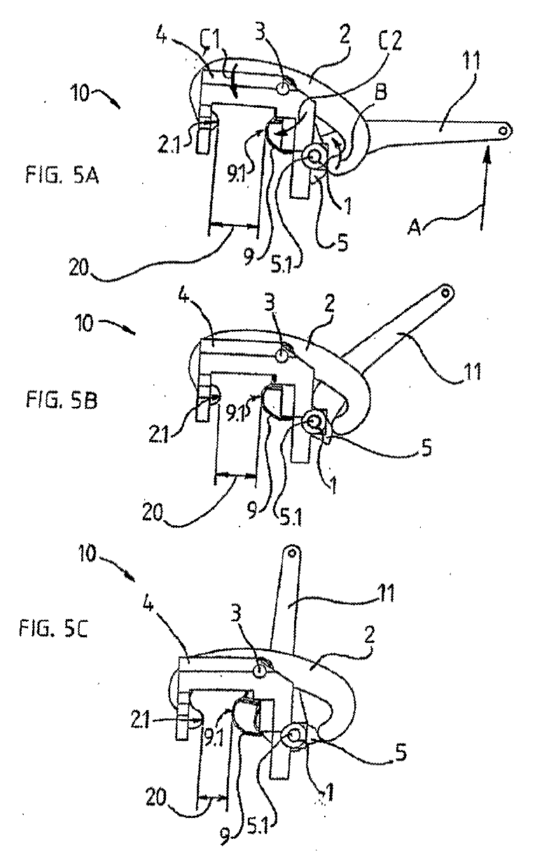

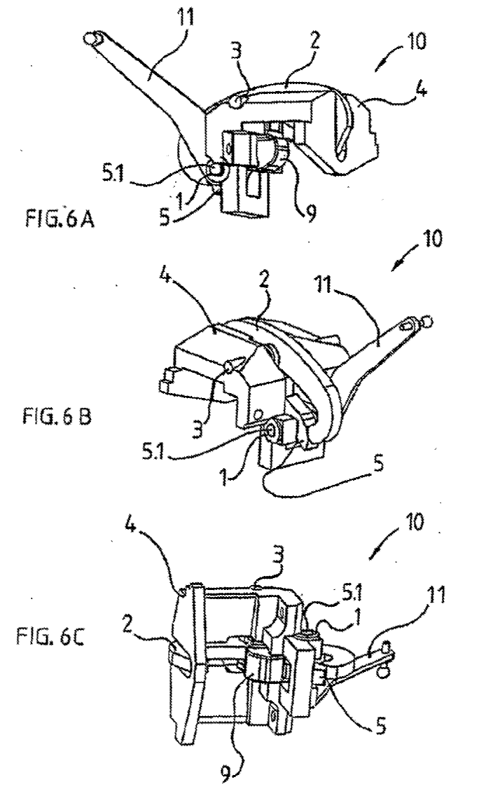

The brake assembly 10 is arranged such that, on the application of a force on the lever 11 in the direction indicated by arrow A in FIG. 5A of the drawings, the cam 5 is displaced angularly to exert a force on the knuckle 9 and the c-shaped arm 2. In consequence, both disc pads 7 and 8 are urged simultaneously into engagement with a disc (not shown) positioned between the pads 7 and 8, as will be described in greater detail below.

The rotatable cam 5 and mounting of the caliper 4 is typically arranged to enable a generally even braking pressure to be applied to the disc (not shown) by both disc pads 7, 8.

The disc pads 7, 8 are guided for movement towards and away from the disc (not shown) by the mounting means on the carrier 6. The mounting means can typically include edges 6.1, 6.2 on the carrier 6 arranged to cooperate with the pads 7, 8 to enable the pads 7, 8 to slide toward and away from each other as indicated by arrows DD. The edge formations 6.1, 6.2 further serve as front and rear abutment means to anchor the disc pads 7, 8 against displacement in the direction of disc rotation.

The brake disc (not shown) can typically be secured to a wheel hub (not shown) of a vehicle in a conventional fashion. The carrier 6 is typically mounted on the vehicle so that the caliper 4 and the disc pads 7, 8 are correctly positioned relative to the brake disc (not shown). The carrier 6 can be secured to the vehicle in a conventional manner, such as by securing it relative to an axle, or suspension, or the like, by means of conventional fasteners, such as nuts and bolts, or the like.

The caliper 4 is typically positioned and secured on the carrier 6 by conventional securing means, such as guide pins, screw threaded fasteners, or the like.

The brake assembly 10 can be used as a parking brake. In such a case, it can be mechanically actuated. Instead, or in addition, it can be used as a braking assembly for use on a trailer, or the like. The brake assembly 10 can then be arranged to be coupled releasably to a brake system of a towing vehicle so as to be actuated in sympathy with actuation of the brake system of the towing vehicle. Transmission of power to the lever 11 can be by means of mechanical, hydraulic or electronic means. The disc pads can be caused to return to an original position after the brake assembly has been actuated by means of resilient means, such as springs, or the like.

The invention can of course be applied to brakes in which the applying means are different from those described above. In particular, there could be a caliper and two arm levers of the same kind as the arm lever 11, operating by way of two cam surfaces of the same kind as the cam 5.

Referring now to FIGS. 5A to 5C of the drawings, the application of the brake assembly 10 will now be described in greater detail.

In FIG. 5A the brake assembly 10 is actuated by angular displacement of the lever 11 as indicated by arrow A. The cam 5 is then caused to displace angularly in sympathy with the lever 11 as indicated by arrow B. It will be appreciated that the lever 11 and the cam 5 are fast with the cam shaft 5.1. The c-shaped arm 2 and the knuckle 9 ride against the cam 5. As mentioned, the c-shaped arm 2 and the knuckle 9 are mounted for angular displacement on the caliper 4 by means of the pin 3. Accordingly, the c-shaped arm 2 and the knuckle 9 are caused to displace angularly on the caliper 4 as indicated by arrows C1 and C2 respectively, in sympathy with angular displacement of the cam 5 in the direction of arrow B. As the c-shaped arm 2 and the knuckle 9 are displaced angularly as indicated by arrows C1, C2, a linear distance 20 between extreme ends 2.1, 9.1 of the c-shaped member 2 and the knuckle 9, is reduced, as can be seen in FIGS. 5B and 5C. Naturally, when the brake pads 7, 8 are mounted on the carrier 6, the brake pads 7, 8 are urged toward each other frictionally to engage a brake disc positioned between the pads 7, 8, in sympathy with the angular displacement of the c-shaped member 2 and the knuckle 9. It will be appreciated that the distance 20 decreases in response to wear of the pads 7, 8, in use.

1. A brake assembly including: a body; mounting means on the body, the mounting means being arranged to enable two brake pads to be mounted on the body such that the brake pads face each other and are selectively displaceable toward and away from each other; urging means on the body, the urging means being arranged selectively to urge the brake pads toward each other; and a cam on the body, the cam being operatively associated with the urging means so as to cause the urging means to urge the brake pads toward each other in response to the cam being displaced angularly, thereby to cause the brake pads frictionally to engage a brake disc, in use.

2. The brake assembly as claimed in claim 1, in which the urging means includes at least one urging member mounted on the body to transfer angular displacement of the cam into displacement of one of the disc pads toward the other.

3. The brake assembly as claimed in claim 2, in which the at least one urging member is mounted on the body at a position to ride against the cam.

4. The brake assembly as claimed in claim 3, in which the at least one urging member is mounted on the body at a position to ride against the cam and against the one brake pad.

5. The brake assembly as claimed in claim 4, which further includes a pivotal connection through which the one urging member is mounted on the body so that angular displacement of the cam causes angular displacement of the one urging member so as to transfer angular displacement of the cam into displacement of the one brake pad.

6. The brake assembly as claimed in claim 4, in which the urging means further includes another urging member mounted on the body to transfer angular displacement of the cam into displacement of the other brake pad toward the one brake pad.

7. The brake assembly as claimed in claim 6, in which the other urging member is mounted on the body at a position to ride against the cam.

8. The brake assembly as claimed in claim 7, in which the other urging member is mounted on the body at a position to ride against the cam and against the other brake pad.

9. The brake assembly as claimed in claim 8, which further includes a pivotal connection through which the other urging member is mounted on the body so that angular displacement of the cam causes angular displacement of the other urging member so as to transfer angular displacement of the cam into displacement of the other brake pad

10. The brake assembly as claimed in claim 9, in which both urging members are mounted on the body by means of the pivotal connection so that angular displacement of the cam causes angular displacement of both urging members so as to transfer angular displacement of the cam into displacement of both brake pads toward each other.

11. The brake assembly as claimed in claim 9, which further includes a lever mounted on the body for angular displacement relative to the body, the lever being operatively connected to the cam to cause the cam to displace angularly in response to angular displacement of the lever.

12. The brake assembly as claimed in claim 11, which further includes a cam shaft mounted on the body for angular displacement relative to the body, the cam and the lever being secured on the cam shaft thereby to be angularly displaceably mounted on the body.

13. A vehicle having a brake assembly as claimed in claim 1.

14. A trailer having a brake assembly as claimed in claim 1.

15. (canceled)
